(19) United States
(12) Patent Application Publication
(10) Pub. No.: US 2007/0190332 A1
(43) Pub. Date: Aug. 16, 2007

(54) Dry-type encapsulated transformer coils

(75) Inventors: Stephane Schaal, Lipsheim (FR); Cherif Ghoul, Mulhouse (FR); Jens Rocks, Zurich (CH); Charles W. Johnson, Wytheville, VA (US)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zurich (CH)

(21) Appl. No.: 11/716,005

(22) Filed: Mar. 9, 2007

Related U.S. Application Data
(63) Continuation of application No. PCT/CH05/00530, filed on Sep. 6, 2005.

(30) Foreign Application Priority Data
Sep. 9, 2004 (EP) 04405563.0

(51) Int. Cl. B32B 27/04; B32B 27/38; C08L 63/00; B32B 27/18

(52) U.S. Cl. 428/413; 525/528

(57) ABSTRACT

A dry-type transformer is disclosed wherein the transformer coils are encapsulated with a cured mineral filler containing cyanate ester resin composition which optionally is a cured mineral filler containing epoxy modified cyanate ester resin composition. A method of making the insulating composition, and the non-cured composition, are also disclosed.

### RELATED APPLICATIONS

This application claims priority under 35 U.S.C. §119 to EP Application 04405563.0 filed in Europe on Sep. 9, 2004, and is a continuation application under 35 U.S.C. §120 of PCT/CH2005/000530 filed as an International Application on Sep. 6, 2005, designating the U.S., the entire contents of which are hereby incorporated by reference in their entireties.

### FIELD

Dry-type transformers are disclosed, such as dry-type distribution transformers, wherein the transformer coils are encapsulated with a cured mineral filler containing cyanate ester resin composition, and wherein as an option, a cured mineral filler is used containing epoxy modified cyanate ester resin composition.

### BACKGROUND INFORMATION

Dry-type transformers are known and described, e.g., in EP 0 923 785 or WO 03/107364. The dry-type transformers can contain windings that can be used as dry-type transformer high- and low-voltage windings. Dry-type transformers are used for distributing electrical energy, within the range of, for example, 5 kVA to 2500 kVA. Dry-type transformers or dry-type distribution transformers comprise coils, such as windings that are generally embedded into a thermosetting insulating material. The insulating material can be a filled epoxy resin and the windings can be manufactured by vacuum casting.

Epoxy resins can possess advantages over other thermosetting polymers. They can be of a low price, be easy to process and have good dielectrical and mechanical properties. However, epoxy resins can have generally limited temperature stability. Transformers can have an increased overload capacity and an extended lifetime. The transformers can be operated at elevated temperatures and therefore, the insulation material should exhibit an improved temperature resistance. This is described, for example, in G. Pritchard, Developments in Reinforced Plastics, Vol. 5, Applied Science (1986), where it is shown that epoxy resins are not suitable for application at elevated temperatures, especially from a thermal point of view. Other technologies were developed, but these can have other disadvantages compared to known coils encapsulated with an epoxy resin wherein the windings are manufactured by vacuum casting, especially with regard to processing and material costs.

### SUMMARY

Materials which are useful for encapsulating transformer coils, such as transformer windings, are disclosed which can have improved temperature stability (compared to epoxy resins) and which can be compatible with known vacuum casting manufacturing techniques. Exemplary embodiments described herein use cyanate ester compositions optionally modified with one or more epoxy resins as an insulation system for transformer coils in dry-type transformers.

### DETAILED DESCRIPTION

Dry-type transformers are disclosed, such as dry-type distribution transformers, wherein the transformer coils are encapsulated with a cured mineral filler containing cyanate ester resin composition. Optionally, a cured mineral filler containing epoxy modified cyanate ester resin composition can be used. The encapsulating composition can be a cured mineral filler containing cyanate ester resin composition optionally modified with one or more epoxy resins.

The mineral filler containing cyanate ester resin composition optionally modified with one or more epoxy resins, such as, insulating composition, can be cured resin composition as obtained from a composition comprising the components (i), (ii) and optionally (iii), wherein component (i) is a cyanate ester resin, which is present within the range of 1%-60% by weight, preferably within the range of 15%-30% by weight, calculated to the total weight of the insulating composition; component (ii) is a mineral filler material, which is present within the range of 20%-80% by weight, preferably within the range of 40%-70% by weight, and preferably within the range of 50%-65% by weight, calculated to the total weight of the insulating composition; and the optional component (iii) is an epoxy resin, which is present within the range of 1%-50% by weight, preferably within the range of 15%-30% by weight, calculated to the total weight of the insulating composition.

Non-cured compositions containing the components (i), (ii) and optionally (iii), and the prepolymers made of the components (i), (ii) and optionally (iii), are disclosed as starting compositions for encapsulating transformer coils within a dry-type transformers, especially within a dry-type distribution transformer. The composition optionally contains further additives as explained further on.

Cyanate ester resins are known compounds and have been described in publications. A cyanate ester resin component, as disclosed herein, can be based on a single-ring cyanate monomer, such as phenyl-1,3-dicyanate, phenyl-1,4-dicyanate, wherein the phenylen ring optionally is additionally substituted by a (C₁₋₄)-alkyl group or phenyl-1,3,5-tricyanate; a phenylene cyanate oligomer or polymer, wherein the phenylene rings optionally are bound together by various bridging atoms or bridging groups such as methylene, 1,1-ethylene, 2,2-propylene, oxygen, carbonyl, carbonyloxy, sulfoxyl [—S(O)₂—] or bis-methylenoxy-dimethylsilyl; a bisphenylcyanate monomer wherein the two phenyl rings optionally are bound together by various bridging atoms or groups such as methylene, 1,1-ethylene, 2,2-propylene, oxygen, carbonyl, carbonyloxy, sulfoxyl or bis-methylenoxy-dimethylsilyl; cyanate monomers based on the naphthalene and anthraquinone structures; fluoroaliphatic dicyanates; carborane dicyanate monomers, or a mixture of these compounds. Such compounds are described e.g. in 1. Hamerton, Chemistry and Technology of Cyanate Ester resins, Chapter 2, Chapman & Hall, (1994), especially pages 34-55. The contents, such as, compounds, of this literature reference is incorporated herein by reference in their entirety.

An exemplary cyanate ester resin component within the insulating composition described herein can be based on the following compounds either as single compounds or as a mixture of these compounds, of formula (I) or formula (II): 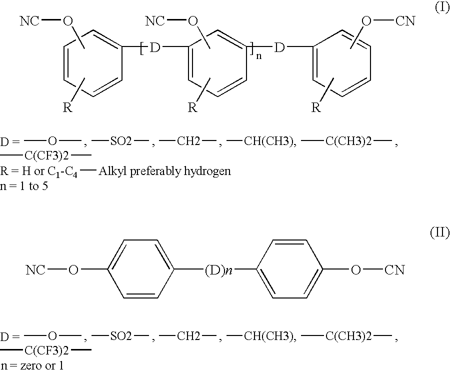
or formula (III):

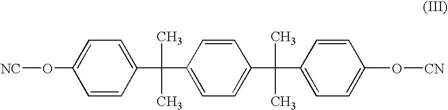

Exemplary preferred compounds are of formula (I) wherein R is hydrogen or compounds of formula (II) wherein D=—CH2— or —C(CH₃)₂—, or a mixture of these compounds.

Exemplary epoxy resins are aromatic and/or cycloaliphatic compounds. These compounds are known per se. Epoxy resins are reactive glycidyl compounds containing at least two 1,2-epoxy groups per molecule. Preferably a mixture of polyglycidyl compounds can be used such as a mixture of diglycidyl- and triglycidyl compounds. It is possible to combine one or more of these glycidyl compounds with a cyanate ester resin component as defined above and obtain a resin composition useful as an encapsulation material. The combination of the two components can be chosen to address optimization.

Epoxy compounds useful for exemplary embodiments described herein comprise unsubstituted glycidyl groups and/or glycidyl groups substituted with methyl groups. These glycidyl compounds preferably have a molecular weight between 200 and 1200, especially between 200 und 1000 and may be solid or liquid. The epoxy value (equiv./100 g) is preferably at least three, preferably at least four and especially at about five, preferably about 4.9 to 5.1. Preferred are glycidyl compounds which have glycidyl ether- and/or glycidyl ester groups. Such a compound may also contain both kinds of glycidyl groups, e.g., 4-glycidyloxy-benzoic acidglycidyl ester. Preferred are polyglycidyl esters with 1-4 glycidyl ester groups, especially diglycidyl ester and/or triglycidyl esters. Preferred glycidyl esters may be derived from aromatic, araliphatic, cycloaliphatic, heterocyclic, heterocyclic-aliphatic or heterocyclic-aromatic dicarbonic acids with 6 to 20, preferably 6 to 12 ring carbon atoms or from aliphatic dicarbonic acids with 2 to 10 carbon atoms. Preferred are for example optionally substituted epoxy resins of formula (IV): 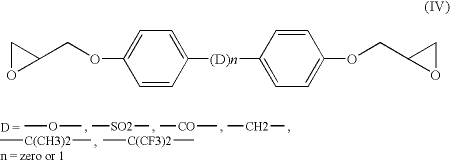
or formula (V):

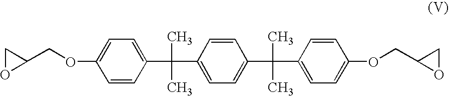

Examples are glycidyl ethers derived from Bisphenol A or Bisphenol F as well as glycidyl ethers derived from Phenol-Novolak-resins or cresol-Novolak-resins.

Cycloaliphatic epoxy resins are for example hexahydro-o-phthalic acid-bis-glycidyl ester, hexahydro-m-phthalic acid-bis-glycidyl ester or hexahydro-p-phthalic acid-bis-glycidyl ester. Also aliphatic epoxy resins, for example 1,4-butane-diol diglycidyl ether, may be used as a component for the exemplary compositions described herein.

Exemplary embodiments can use aromatic and/or cycloaliphatic epoxy resins which contain at least one, preferably at least two, aminoglycidyl group in the molecule. Such epoxy resins are known and for example described in WO 99/67315. Preferred compounds are those of formula (VI):

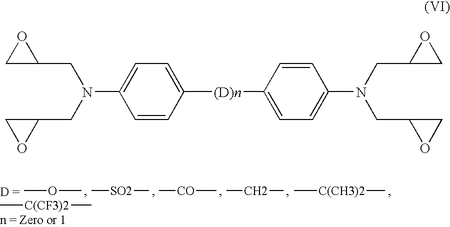

Especially suitable aminoglycidyl compounds are N,N-diglycidylaniline, N,N-diglycidyltoluidine, N,N,N′,N′-tetraglycidyl-1,3-diaminobenzene, N,N,N′,N′-tetraglycidyl-1,4-diaminobenzene, N,N,N′,N′-tetraglycidylxylylendiamine, N,N,N′,N′-tetraglycidyl-4,4′-diaminodiphenylmethane, N,N,N′,N′-tetraglycidyl-3,3′-diethyl-4,4′-diaminodiphenylmethane, N,N,N′,N′-tetraglycidyl-3,3′-diaminodiphenylsulfone, N,N′-Dimethyl-N,N′-diglycidyl-4,4′-diaminodiphenylmethane, N,N,N′,N′-tetraglycidyl-alfa,alfa′-bis(4-aminophenyl)-p-diisopropylbenzene and N,N,N′,N′-tetraglycidyi-alfasalfa′-bis-(3,5-dimethyl-4-aminophenyl)-p-diisopropylbenzene.

Exemplary aminoglycidyl compounds are also those of formula (VII): 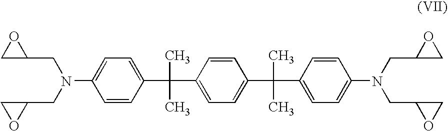
or of formula (VIII):

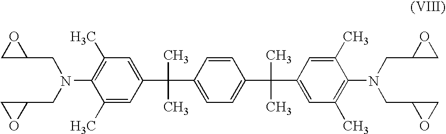

Further aminoglycidyl compounds which can be used are described in e.g., Houben-Weyl, Methoden der Organischen Chemie, Band E20, Makromolekulare Stoffe, Georg Thieme Verlag Stuttgart, 1987, pages 1926-1928, the contents of which are incorporated herein by reference in their entirety.

Mineral filler materials for electrical applications are known. Such materials are for example glass powder, metal oxides such as silicon oxide (Aerosil, quarz, fine quarz powder), magnesium- and aluminium hydroxide [Mg(OH)₂, Al(OH)₃, AlO(OH)], titanium oxide; metal nitrides, such as silicon nitride, boron nitride and aluminium nitride; metal carbides, such as silicon carbide (SiC); metal carbonates (dolomite, CaCO₃), metal sulfates (e.g., baryte), ground natural and synthetic minerals mainly silicates, such as talcum, glimmer, kaolin, wollastonite, bentonite; calciumsilicates such as xonolit [Ca₂Si₆O₁₇(OH)₂]; aluminiumsilicates such as andalusite [Al₂O₃.SiO₂] or zeolithe; calcium/magnesium carbonates such as dolomite [CaMg(CO₃)₂]; and known calcium/magnesium silicate, in different powder sizes. Preferred are silicon oxide and/or aluminium oxide, xonolite, magnesium- and aluminium hydroxide, ground natural stones, ground natural and synthetic minerals derived from silicates. The filler material has, for example, preferably an average granular size within the range of 1 μm to 300 μm, preferably within the range of 5 μm to 100 μm.

The filler material may optionally be coated for example with a silane or a siloxane known for coating filler materials, e.g., dimethylsiloxanes which may be cross linked, or other known coating materials. These compounds have been published at many publications and are incorporated herein by reference.

The silane, e.g., a trialkylsilane or a phenyldimethylsilane, or the polysiloxanes used for coating the filler material may contain reactive groups such as hydroxyl, hydrosilyl groups (—Si—H), carboxyl groups, (C₁-C₄)alkyl-epoxy, vinyl (≡Si—CH═CH₂) or Allyl (≡Si—CH₂CH═CH₂), and preferably have a viscosity within the range of about 0.97 mPa·s (1 cSt) to about 19'500 mPa·s (measured according to DIN 53 019 at 25° C., calculated with a density of 0.97) and may be linear, two-dimensional or three-dimensional compounds, such as, compositions, a mixture of oligomeric compounds or a mixture of the named compounds.

The viscosity of these organopolysiloxanes can, for example, be preferably within the range of about 0.97 mPa·s (1 cSt) to about 4900 mPa·s, preferably within the range of 2 mPa·s to 2900 mPa·s, preferably within the range of 5 mPa·s to 700 mPa·s, according to DIN 53 019 at 25° C. Preferably the polysiloxanes have an average molecular weight within the range of about 300 to 100'000, preferably about 300 to 50'000, preferably 400 to 10'000 Dalton.

The filler material optionally may be present in a “porous” form. As a “porous” filler material, which optionally may be coated, is understood, that the density of said filler material is within the range of 60% to 80%, compared to the “real” density of the non-porous filler material. Such porous filler materials have a much higher total surface than the non-porous material. The surface can preferably be higher than 20 m2/g (BET m2/g) and preferably higher than 30 m2/g (BET) and preferably is within the range of 30 m2/g (BET) to 100 m2/g (BET), preferably within the range of 40 m2/g (BET) to 60 m2/g (BET). The porous filler material may be coated with a siloxane, preferably with an organopolysiloxane which may be cross linked, with up to 50%-80% by weight, preferably from 60%-70% by weight, calculated to the total weight of the coated filler material.

The insulating composition encapsulating the transformer coils may contain further additives such as hardeners, curing agents, plasticizers, antioxidants, light absorbers, as well as further additives used in electrical applications.

Hardeners are known to be used in epoxy resins. In the present composition such hardeners are only optional. Hardeners are for example hydroxyl and/or carboxyl containing polymers such as carboxyl terminated polyester and/or carboxyl containing acrylate- and/or methacrylate polymers and/or carboxylic acid anhydrides. Useful hardeners are further cyclic anhydrides of aromatic, aliphatic, cycloaliphatic and heterocyclic polycarbonic acids. Preferred anhydrides of aromatic polycarbonic acids are phthalic acid anhydride and substituted derivates thereof, benzene-1,2,4,5-tetracarbonic acid dianhydride and substituted derivates thereof. Numerous further hardeners are from the literature.

The optional hardener can be used in concentrations within the range of 0,2 to 1,2, equivalents of hardening groups present, e.g., one anhydride group per 1 epoxide equivalent. However, a concentration within the range of 0,2 to 0.4, equivalents of hardening groups can, for example, be preferred.

Curing agents are for example tertiary amines, such as benzyldimethylamine or amine-complexes such as complexes of tertiary amines with boron trichloride or boron trifluoride; urea derivatives, such as N-4-chlorophenyl-N′,N′-dimethylurea (Monuron); optionally substituted imidazoles such as imidazole or 2-phenyl-imidazole. Preferred are tertiary amines. Other curing catalyst such as transition metal complexes of cobalt(III), copper, manganese(II), zinc in acetylacetonate may also be used, e.g. cobalt acetylacetonate(III). The amount of catalyst used is a concentration of about 50 ppm-1000 ppm by weight, calculated to the composition to be cured.

The insulating composition can be made simply by mixing all the components, optionally under vacuum, in any desired sequence and curing the mixture by heating. Preferably the hardener and the curing agent are separately added before curing. The curing temperature can be preferably within the range of 50° C. to 280° C., preferably within the range of 100° C. to 200° C. Curing generally is possible also at lower temperatures, whereby at lower temperatures complete curing may last up to several days, depending also on catalyst present and its concentration.

For encapsulating the transformer coil with the insulating composition, the transformer coil can be placed into a mold and the insulation composition added. It is then possible to heat the composition, e.g., by applying an electrical current to the coil to resistively heat the composition to a desired temperature and for a time long enough, optionally under the application of vacuum, to remove all moisture and air bubbles from the coil and the insulating composition. The encapsulating composition may then be cured by any method known in the art by heating the composition to the desired curing temperature.

### EXAMPLES 1 AND 2

The coils, such as windings, of a dry-type distribution transformer are encapsulated with a thermosetting insulating material made of a filler containing epoxy modified cyanate ester resin system. The electrical, mechanical and processing properties are compared with the same coils, such as, windings encapsulated with a conventional epoxy resin. As shown, the coils of the dry-type distribution transformer encapsulated with a filler containing epoxy modified cyanate ester resin system show much better properties. The recipes used are given in Table 1.

TABLE 1

| COMPONENTS | REFERENCE | Example 1 | Example 2 |
|---|---|---|---|
| epoxy resin 1 | 100 | — | 50 |
| Hardener 2 | 82 | — | |
| Accelerator 3 | 2 | — | |
| cyanate ester 4 | — | 100 | 50 |
| Co-catalyst 5 | — | — | 100 ppm |
| filler (silica flour) 6 | 322 | 175 | 175 |

1 VE4518 Comp. A supplied by Bakelite AG (new name EPR 845)
2 VE4518 Comp. B supplied by Bakelite AG (new name EPH 845)
3 VE4518 Comp. C supplied by Bakelite AG (new name EPC 845)
4 Primaset PT-15 supplied by Lonza AG
5 Cobalt acetylacetonate supplied by Shepherd
6 Millisil W12 supplied by Quarzwerke
All of the formulations of Table 1 contain the same amount of filler (63.6% wt.).

The epoxy component is a Bisphenol A/F mixture with an epoxy equivalent of 4.9-5.1 (equiv./100 g).

Short term dynamic degradation was performed by heating the materials at 10° C./minute from ambient temperature to 800° C. by using a thermo gravimetric analyzer (TGA). The onset of degradation was measured and reported in Table 2 shown below. The data shows that the onset of thermal degradation is higher for the formulations of the invention than for the reference. This indicates a higher thermal stability of exemplary formulations disclosed herein.

It is generally accepted by those familiar with the vacuum casting process that a material with a dynamic viscosity value of 10 Pa·s or below is suitable for the mentioned process. Steady state viscosity data show that all of the materials are suitable for a casting process.

Long term thermo-oxidative ageing characteristics were also evaluated. Accelerated ageing was performed at 260° C. and flexural strength (ISO 178) was measured before and after 100 and 200 hours ageing. The fraction of the remaining flexural strength after ageing was calculated. The higher that fraction, the better the resistance to thermal ageing. It is clear from Table 2 below that the invention formulations exhibit a significantly improved resistance to thermal ageing compared to the reference.

TABLE 2

| PROPERTY | REFERENCE | Ex. 1 | Ex. 2 |
|---|---|---|---|
| Onset of thermal degradation | 360 | 410 | 371 |
| (° C.) | | | |
| Steady state viscosity | 1.0 | 2.2 | 1.4 |
| at 75° C. (Pa · s) | | | |
| % of initial flexural | 66 | 92 | 94 |
| strength after 100 h at 260° C. | | | |
| % of initial flexural | 12 | 83 | 88 |
| strength after 200 h at 260° C. | | | |

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Dry-type transformer comprising:
transformer coils encapsulated with a cured mineral filler containing cyanate ester resin composition, which optionally is a cured mineral filler containing an epoxy modified cyanate ester resin composition.

2. Dry-type transformer according to claim 1, wherein said cured resin composition is obtained from a composition comprising:
components (i), (ii) and optionally (iii), wherein component (i) is a cyanate ester resin, which is present within a range of 1%-60% by weight, preferably within a range of 15%-30% by weight, calculated to a total weight of the insulating composition; component (ii) is a mineral filler material, which is present within a range of 20%-80% by weight, preferably within a range of 40%-70% by weight, and preferably within a range of 50%-65% by weight, calculated to the total weight of the insulating composition; and the optional component (iii) is an epoxy resin, which is present within a range of 1%-50% by weight, preferably within a range of 15%-30% by weight, calculated to the total weight of the insulating composition.

3. Dry-type transformer according to claim 1, wherein the cyanate ester resin within the insulating composition is based on a single-ring cyanate monomer, preferably phenyl-1,3-dicyanate, phenyl-1,4-dicyanate, wherein the phenylen ring optionally is additionally substituted by an (C1-4)-alkyl group or phenyl-1,3,5-tricyanate; a phenylene cyanate oligomer or polymer, wherein the phenylene rings optionally are bound together by various bridging atoms or bridging groups preferably methylene, 1,1-ethylene, 2,2-propylene, oxygen, carbonyl, carbonyloxy, sulfoxyl or bis-methylenoxydimethylsilyl; a bisphenylcyanate monomer wherein the two phenyl rings optionally are bound together by various bridging atoms or groups preferably methyllene, 1,1-ethylene, 2,2-propylene, oxygen, carbonyl, carbonyloxy, sulfoxyl or bis-methylenoxy-dimethylsilyl; cyanate monomers based on the naphthalene and anthraquinone structures; fluoroaliphatic dicyanates; carborane dicyanate monomers, or a mixture of these compounds.

4. Dry-type transformer according to claim 1, wherein said cyanate ester resin component is based on the following compounds either as single compounds or as a mixture of these compounds, of formula (I) or formula (II): 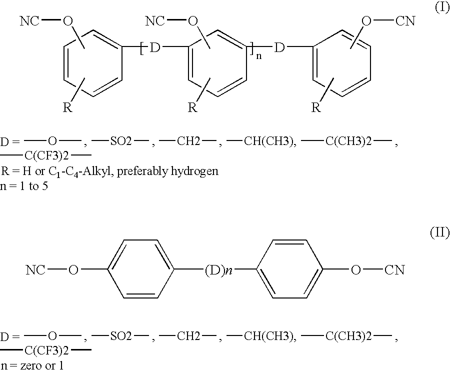
or formula (III):

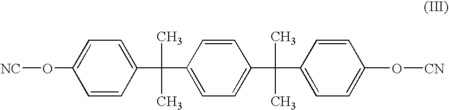

5. Dry-type transformer according to claim 4, wherein R of formula (I) is hydrogen or wherein D of formula (II) is —CH2— or —C(CH3)2—.

6. Dry-type transformer according to claim 1, wherein the optionally present epoxy resin is based on aromatic and/or cycloaliphatic reactive glycidyl compounds containing at least two 1,2-epoxy groups per molecule, preferably a mixture of polyglycidyl compounds, preferably a mixture of diglycidyl- and triglycidyl compounds.

7. Dry-type transformer according to claim 6, wherein the epoxy compound comprises:
unsubstituted glycidyl groups and/or glycidyl groups substituted with methyl groups, preferably having a molecular weight between 200 and 1200, preferably between 200 und 1000.

8. Dry-type transformer according to claim 6, wherein the epoxy value (equiv./100 g) of the epoxy resin is at least three, preferably at least four and especially at about five, preferably about 4.9 to 5.1.

9. Dry-type transformer according to claim 1, wherein the epoxy resin corresponds to formula (IV): 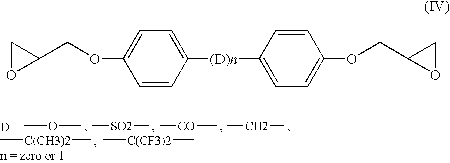
or formula (V):

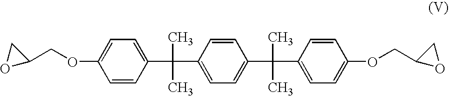

10. Dry-type transformer according to claim 1, wherein the epoxy resin is an aromatic and/or cycloaliphatic epoxy resins which contain at least one, preferably at least two, aminoglycidyl groups in the molecule, preferably corresponding to formula (VI): 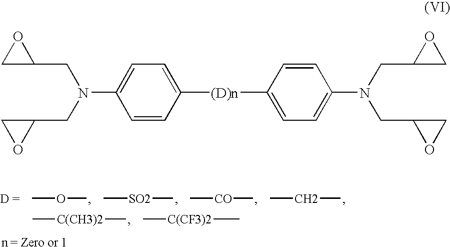
or formula (VII): 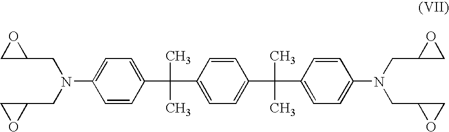
or of formula (VIII):

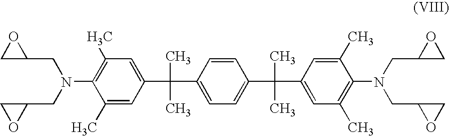

11. Dry-type transformer according to claim 1, wherein the mineral filler material is selected from the group consisting of glass powder, metal oxides preferably silicon oxide (Aerosil, quarz, fine quarz powder), magnesium- and aluminium hydroxide [Mg(OH)₂, Al(OH)₃, AlO(OH)₂], titanium oxide; metal nitrides, preferably silicon nitride, boron nitride and aluminium nitride; metal carbides, preferably silicon carbide (SiC); metal carbonates (dolomite, CaCO₃), metal sulfates (e.g., baryte), ground natural and synthetic minerals mainly silicates, preferably talcum, glimmer, kaolin, wollastonite, bentonite; calciumsilicates preferably xonolite [Ca₂Si₆O17(OH)₂]; aluminiumsilicates, preferably andalusite [Al₂O₃.SiO₂] or zeolithe; calcium/magnesium carbonates, preferably dolomite [CaMg(CO₃)₂]; and known calcium/magnesium silicate, in different powder sizes.

12. Dry-type transformer according to claims 11, wherein the mineral filler material is selected from the group consisting of silicon oxide, aluminium oxide, xonolite, magnesium hydroxide, aluminium hydroxide, ground natural stones, ground natural and synthetic minerals derived from silicates, preferably with an average granular size within a range of 1 μm to 300 μm, preferably within a range of 5 μm to 100 μm.

13. Dry-type transformer according to claim 1, wherein the mineral filler material is coated with a silane or a siloxane, preferably with a dimethylsiloxane which may be cross linked.

14. Dry-type transformer according to claim 13, wherein the silane or the siloxane contains reactive groups selected from the group consisting of hydroxyl, hydrosilyl groups (≡Si—H), carboxyl groups, (C₁-C₄)alkyl-epoxy, vinyl (≡Si—CH═CH₂) or Allyl (≡Si—CH₂CH═CH₂).

15. Dry-type transformer according to claim 13, wherein the silane or the siloxane have a viscosity within a range of about 0.97 mPa·s (1 cSt) to about 19'500 mPa·s (measured according to DIN 53 019 at 25° C., calculated with a density of 0.97), preferably within a range of 0.97 mPa·s (1 cSt) to 4900 mPa·s, preferably within a range of 2 mPa·s to 2900 mPa·s, preferably within a range of 5 mPa·s to 700 mPa·s, according to DIN 53 019 at 25° C.

16. Dry-type transformer according to claim 13, wherein the polysiloxane has an average molecular weight within a range of about 300 to 100'000, preferably about 300 to 50'000, preferably 400 to 10'000 Dalton.

17. Dry-type transformer according to claim 1, wherein the filler material is a “porous” filler material, of which a density is within the range of 60% to 80%, compared to real density of the non-porous filler material, preferably having a total surface higher than 20 m²/g (BET m²/g), preferably higher than 30 m²/g (BET), preferably within a range of 30 m²/g (BET) to 100 m²/g (BET), preferably within a range of 40 m²/g (BET) to 60 m²/g (BET).

18. Dry-type transformer according to claim 1, wherein the insulating composition encapsulating the transformer coils contains further additives selected from the group consisting of hardeners, curing agents, plasticizers, antioxidants, light absorbers, as well as further additives used in electrical applications.

19. Dry-type transformer according to claim 18, wherein the hardener is a known hardener for the used in epoxy resins and is present in concentrations within a range of 0,2 to 1,2, equivalents of hardening group per 1 epoxide equivalent, preferably within a range of 0,2 to 0.4, equivalents of hardening group.

20. Method of making an insulating composition by mixing a cured mineral filler containing cyanate ester resin composition, which optionally is a cured mineral filler containing an epoxy modified cyanate ester resin composition, optionally under vacuum, in any desired sequence, comprising:
separately adding a hardener and curing agent to the mixture before curing; and
curing the mixture by heating the mixture to a temperature within a range of 50° C. to 280° C., preferably within a range of 100° C. to 200° C., or curing at lower temperatures up to several days, as a function of a catalyst present and its concentration.

21. A non-cured composition, containing:
components (i), (ii) and optionally (iii), wherein component (i) is a cyanate ester resin, which is present within a range of 1%-60% by weight, preferably within a range of 15%-30% by weight, calculated to a total weight of the insulating composition; component (ii) is a mineral filler material, which is present within a range of 20%-80% by weight, preferably within a range of 40%-70% by weight, and preferably within a range of 50%-65% by weight, calculated to the total weight of the insulating composition; and the optional component (iii) is an epoxy resin, which is present within a range of 1%-50% by weight, preferably within a range of 15%-30% by weight, calculated to the total weight of the insulating composition.

22. The non-cured composition of claim 21, in combination with a dry-type transformer.

23. Dry-type transformer according to claim 1, wherein the transformer is a dry-type distribution transformer.
